(19) United States
(12) Patent Application Publication
(10) Pub. No.: US 2017/0169857 A1
(43) Pub. Date: Jun. 15, 2017

(54) Method and Electronic Device for Video Play

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yanfang ZHAO, Beijing (CN)

(21) Appl. No.: 15/239,786

(22) Filed: Aug. 17, 2016

Related U.S. Application Data
(63) Continuation of application No. PCT/CN2016/088477, filed on Jul. 4, 2016.

(30) Foreign Application Priority Data
Dec. 15, 2015 (CN) 201510938804.0

(51) Int. Cl. G11B 27/10; H04N 9/87; G11B 27/34; G11B 27/19

(52) U.S. Cl. CPC G11B 27/102; G11B 27/19; H04N 9/8715; G11B 27/34

(57) ABSTRACT

A video play method includes: providing, for a video, a comment list comprising at least one comment tag to a user, wherein each of the at least one comment tag is correlated to a comment audio on the video, the comment audio has an audio start time point corresponding to a play time point of the video; playing the comment audio when the video is played to a play time point corresponding to the audio start time point of a comment audio; and clearing or closing the comment tag corresponding to the comment audio in the comment list, after the playback of the comment audio is finished or stopped by the user.

### CROSS-REFERENCE TO RELATED APPLICATION

The present disclosure is the continuous application of the PCT application PCT/CN2016/088477, filed on Jul. 4, 2016. The present disclosure claims priority to Chinese Patent Application CN201510938804.0 filed Dec. 15, 2015, titled “VIDEO PLAY METHOD AND VIDEO PLAY SYSTEM”, the entire contents of both of which are incorporated herein by reference.

### TECHNICAL FIELD

The present disclosure relates to the field of multimedia technology, and in particular, to a method and electronic device for video play.

### BACKGROUND

Comment is a joking interaction mode on network, and it is a communication method used by netizens for expressing their opinions on a certain object, for example, a joking comment on a certain network video. Wherein, a comment mode such as bullet screen may be employed. In a network communication mode, literals are often used for expressing a thought; correspondingly, joking comments are mostly expressed and read in literals.

However, when literals are used as communication carrier, a user can know that others are communicating with him/her or focusing on his/her literals, but the user cannot know the emotion of others. Thus, it is indirect and insufficient in emotional communication, and the same literals may reflect different meanings under different emotions. Thus, it may be seen that, the communication that takes only literals as carrier cannot convey the real thought, and upon reading a literal comment, the user cannot truly know the real thought of the reviewer. Moreover, the literal comment mode, such as bullet screen, updating the comments by rolling, which occupies a large part of the visual image and interferes with the viewing of the video by the user.

### SUMMARY

The present disclosure put forwards a video play method and electronic device, which can provide a more vivid comment environment and a more comfortable visual effect to a viewer.

In a first aspect, one embodiment of the present disclosure provides a video play method, which includes:

providing, for a video, a comment list including at least one comment tag to a user, wherein each of the at least one comment tag is correlated to a comment audio on the video, the comment audio has an audio start time point corresponding to a play time point of the video;

playing the comment audio when the video is played to a play time point corresponding to the audio start time point of a comment audio;

clearing or closing the comment tag corresponding to the comment audio in the comment list after the playback of the comment audio is finished or stopped by the user.

In a second aspect, the embodiment of the present disclosure provides a non-volatile computer-readable storage medium storing computer-executable instructions configured to execute any one of the above-mentioned video play methods of the present disclosure.

In a third aspect, the embodiment of the present disclosure provides a electronic device including: at least one processor; and memory; wherein the memory stores instructions executable by the one or more processor, and the instructions are configured to execute any one of the above-mentioned video play methods of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

The figures of the embodiments are briefly described as follows to illustrate the examples of the present disclosure or technical solutions in the prior art more clearly. Obviously, the figures described as below are merely some embodiments of the present disclosure, and one of ordinary skilled in the art can obtain other figures according to these figures without creative efforts.

FIG. 1 is a schematic flow chart of a video play method according to a embodiment of the present disclosure;

FIG. 2 is a screen shot showing the software operation of a video play method according to a embodiment of the present disclosure; and

FIG. 3 is a block diagram of the electronic device that executes the video play method according to the embodiment of the present disclosure.

### DETAILED DESCRIPTION

In order to make the objects, technical solutions and advantages of the present disclosure more apparent, the present disclosure will be further illustrated in detail in conjunction with specific embodiments and referring to the drawings.

The present disclosure put forwards a video play method, which can provide a more vivid comment environment and a more comfortable visual effect to a viewer.

FIG. 1 is a schematic flow chart of a video play method according to one embodiment of the present disclosure.

It may be seen for the embodiment as shown in FIG. 1 that, a video play method includes:

In step 110, for a video, a comment list including at least one comment tag is provided to a user, wherein each of the at least one comment tag is correlated to a comment audio on the video, the comment audio has an audio start time point corresponding to a play time point of the video;

In step 120, the comment audio is played when the video is played a the play time point corresponding to the audio start time point of a comment audio;

In step 130, the comment tag corresponding to the comment audio in the comment list is cleared or closed after the playback of the comment audio is finished or stopped by the user.

A study shows that, in the expression modes of emotion, voice occupies 38% in emotion activation. In addition to more truly expressing the mood and feeling of a person, voice can also convey the individuality of the person.

Thus, by employing the video play method of the present disclosure, when a video is played to a time corresponding to the audio start time point of a certain comment audio, the comment audio will be played for the viewer, so that while a user is viewing the video, the user can “hear” the emotional and individualized voice comment of a netizen on the video, rather than “reading” the comment of a netizen on the video in the existing literal mode such as bullet screen. On one hand, the viewer can be made to view the video and at the same time listen a comment, thus a vivid feeling that a plurality of netizens view the video and chat and comment on the video together may be created; on the other hand, the interference of rolling literal comments, such as bullet screen, on the video picture may be avoided, and hence a more comfortable visual effect may be provided to the viewer. Thus, it can be seen that, by such a video play method, a more vivid comment environment and a more comfortable visual effect can be provided to a viewer.

It should be understood that, the “netizen” mentioned here may be a free netizen, or a company netizen from a video website or a comment forum, that is, the comment audio provided by a netizen may come from an individual person, or from a company or other organizations.

It should be understood that, in one embodiment, for example, the comment list may be provided to the user before video play for the user to correspondingly select and configure the comment tags (and related comment audios) in the comment list according to the user's needs. However, in another embodiment, for example, the comment list may also be provided to the user at the start of video play. In yet another embodiment, for example, the comment list may also be provided to the user during the play of the video at a time corresponding to the audio start time point of the first comment audio, or at a preset time point before said time; for example, the audio start time point of the first comment audio is 8′35″, and the comment list may be provided to the user when the video is played to 30″ (which may be preset) before this time (i.e., 8′5″), on one hand, the comment list may be provided to the user slightly before the oncoming first comment audio, so that the user can perform the corresponding selection and configuration, and on the other hand, the visual influence on the viewing of the video by the user due to a comment list provided too early may be avoided.

It should be understood that, in one embodiment, the comment audio in the comment list may be prerecorded, for example, the comment audio may be recorded by a netizen that has viewed the video and uploaded to the video system for a later viewer. However, in another embodiment, the comment audio in the comment list may be recorded by a netizen that is viewing the video online and uploaded to the video system in real time, for example, the netizen and the viewer view the same video at the same time, but the netizen starts earlier than the viewer, thus the netizen may record a comment audio for being listened to by the later viewer. Therefore, when a user views the video, the user may hear the content of joking comments of other users, and the user himself/herself may join and provide a comment audio, and the more users join, the more voices can be heard, thereby a vivid feeling that a lot of people view the video and chat together may be created.

In the video play method, the audio start time point of the comment audio corresponds to the play time point of the video. In one embodiment, the time point may be accurated to 1 s, 0.1 s or 0.01 s, so that a comment audio may be inserted more accurately during video play.

After the playback of the comment audio is finished or stopped by the user, the comment tag corresponding to the comment audio is cleared or closed in the comment list. Here, the “clear” refers to that the comment tag corresponding to the comment audio disappears from the comment list. Here, the “close” refers to that the comment tag corresponding to the comment audio disappears from the comment list, or it is hidden (for example, it may be hidden in a hidden folded menu on the side edge of the comment list, which is displayed only when being pointed to or clicked on by a mouse) or dimmed in color or brightness.

Optionally, in one embodiment, the comment menu includes a comment play history record, by which a user can view the history record of the comment audios that have been played, cleared or closed, or filtered (which will be further described in detail below).

In one optional embodiment, for example, the video viewed is a network video, and a user view the network video online and may listen to the comment audios from other viewers (for example, netizens). However, in another embodiment, the user may view a local video offline, and the comment audio on the video has been downloaded to the local or has been integrated into the local video, thereby the user may view the local video and listen to the comment audios from other viewers.

The video play method according to the present disclosure may be applied to the joking comment mode of any content, for example, voice bullet screen, voice comment and voice chat room, etc. For example, a comment audio-related module function may be packaged to form an open application programming interface (API), and a user terminal on the applying part may call the corresponding function and content (for example, the uploading, acquiring, screening and playing of a comment audio, and the corresponding adjustment of video play volume, etc.,) via the API interface by an application request, thereby realizing the listening to the comment audio.

Optionally, in any embodiment of the present disclosure:

When the comment audio is being played, the volume of the video is lowered (for example, to 70% or less of its original volume);

When the playback of the comment audio is finished or stopped or paused by the user, the volume of the video is recovered to its original volume.

Thus, it may guarantee that the comment voice can be heard clearly by the viewer. The adjustment on the video volume may be set default, or it may be configured by the viewer. For example, in one preferred embodiment, when a comment audio is played, the volume of the video may be lowered to 50% or less of its original volume.

Optionally, in any embodiment of the present disclosure, when a plurality of comment audios are played simultaneously, the number of the plurality of comment audios will not exceed 3.

According to the ordinary recognition ability of human ear, if the number of comments heard simultaneously exceeds 3, the mutual interference will be exacerbated, thus the comments cannot be heard clearly. Therefore, the number of comment voices heard by a user simultaneously should not exceed 3, more preferably, should not exceed 2, for example, it may be only 1.

In one embodiment, if the total number of available comment audios exceeds 3, the comment audios may be ordered according to the priorities thereof, wherein a plurality of comment audios with the highest priority, the number of which does not exceed 3, may be played simultaneously. For the priority, more detailed description will be given below. In such a case, the rest of the comment audios that are not played may wait in a comment list, for example, after the playback of a comment audio is finished or stopped, the comment audio with the highest priority among the comment audios that are waiting may be activated (for example, automatically activated) and played.

However, in another embodiment, if the total number of available comment audios exceeds 3, a plurality of comment audios with a number no larger than 3 may be selected randomly (or, manually by a user) for being played simultaneously.

Optionally, in any embodiment of the present disclosure, a specific comment audio may be played or stopped or paused by the manual selection of a user. Thus, a user may have the highest control right on the comments to be listened to. For example, when 3 comments are heard simultaneously, a user may manually stop a comment that the user is not interested in, and manually pause a common comment, and only listen to a comment the user is the most interested in; and after this comment is finished, the user may continue to listen to the common comment (manually, or automatically as configured).

Optionally, in any embodiment of the present disclosure, when the video is played to a first play time point corresponding to the audio start time point of first comment audio, the first comment audio is played;

When the video is played to a second play time point, which is behind the first play time point, corresponding to the audio start time point of the second comment audio, the playback of the first comment audio is stopped and the second comment audio is played.

Thus, when a scenario in a video (for example, the first scenario, which may correspond to the first play time point) comes, the first comment audio corresponding to the first play time point is played; when a new scenario in the video (for example, the next scenario or the second scenario, which may correspond to the second play time point) comes, the playback of the comment audio on the previous scenario (i.e., the first comment audio corresponding to the first play time point) is stopped, and the second comment audio on the new scenario is played, so that the listening to the comment on the new scenario in the video will not be interfered.

Optionally, in one embodiment, the play of the video and the play of the comment audio may be independent from each other. For example, in one preferred embodiment, the play of the video may be paused by the user manually, and continued (for example, it may be continued automatically or manually by the user) after the playback of the comment audio is finished. Thus, for a comment the user is interested in, the user may pause the play of the video and continue to view the video after the listening to the comment.

Optionally, in any embodiment of the present disclosure, in a case where the audio start time points of a plurality of comment audios correspond to the same play time point, said plurality of comment audios may be arranged and/or played in the comment list in sequence according to their priorities, wherein the priorities are determined based on one or more of the audio time length, the audio source and the audio author of each of the comment audios. It should be understood that, the priority may be set according to system default, and it may also be configured in advance or in real time by the user; for example, it may be configured during video play or configured when the play of the video is paused.

In one embodiment, in a case where the audio start time points of a plurality of comment audios correspond to the same play time point, the plurality of comment audios may be arranged in the comment list in sequence according to their priorities, which will be further described in detail below.

In one embodiment, in a case where the audio start time points of a plurality of comment audios correspond to the same play time point, said plurality of comment audios may be played in sequence according to their priorities, especially when said plurality of comment audios are all short or when the play time point of the next comment audio is late and thus the user has enough time to listen to said plurality of comment audios, thereby the user may listen to each of said plurality of comment audios separately and clearly in sequence, rather than listening to said plurality of comment audios simultaneously and hence causing mutual interference. This is especially advantageous when the number of available comment audios is small.

However, on the other hand, in a case where the audio start time points of a plurality of comment audios correspond to the same play time point and the number of available comment audios is large (for example, exceeding 3), these comment audios may be order according to their priorities, wherein a plurality of comment audios with the highest priority, the number of which does not exceed 3, may be played simultaneously, as described above, and the detailed description thereof will be therefore omitted.

Optionally, in any embodiment of the present disclosure, only a comment tag that meets a filter condition is displayed in the comment list, wherein, the filter condition includes: audio time length of the comment audio corresponding to the comment tag being in a preset range (for example, longer than or shorter than a preset value, or between a maximum value and a minimum value), source of the comment audio (for example, a website or a forum) and author of the comment audio.

Thus, unwanted comment audios may be filtered off, and only comment audios the user focuses on are displayed in the comment list for playing, which is especially advantageous when the number of available comment audios is large.

Optionally, in any embodiment of the present disclosure, the comment tag displays one or more of the attributes of the comment audio (for example, audio start time point, audio time length, audio source and audio author).

In one embodiment, these attributes displayed by the comment tag may be displayed in literals, or they may be displayed by a static or dynamic image. For example, the comment tag displays the audio time length by literals (or digit), and displays the audio author by a static image (for example, author head portrait), and displays the audio author of the comment audio being played by a dynamic image (for example, a blinking image).

In one embodiment, different comment audios of a certain attribute, for example, different comment audios from different authors, or different comment audios from different websites, may be distinguished by different colors. Optionally, in one embodiment, the comment tags of the comment audios from the website that provides the video may be highlighted by red color, and the comment tags of the comment audios from other audio sources may be displayed in other color in a non-highlighted mode.

In one embodiment, in the comment list, the comment tags of the comment audio that are being played display more attributes than the comment tags of the available comment audios in waiting, thus more detailed reviewer information may be provided to the user.

In another embodiment, in the comment list, the comment tags of the available comment audios in waiting display more attributes than the comment tag of the comment audio that is being played, which is favorable for a user to manually select a comment audio to be listened to according to the reviewer information.

In one embodiment, for example, when the number of available comment audios is large, the user may clear (i.e., filter off) some of them according to the attributes, for example, a comment audio with an audio time length exceeding a preset value may be cleared, or a comment audio from a specific audio author may be cleared. Thereby, the user may only listen to short comment audios with an audio time length not exceeding the preset value and screen off the comment audio from a specific audio author.

In another embodiment, for example, when the number of available comment audios is large, the user may select some of them for playing according to the attribute, for example, a comment audio with an audio time length not exceeding the preset value (for example, 5 s) may be selected, or a comment audio from a specific audio source (for example, a website or a forum) may be selected. Thereby, the user may only listen to short comment audios with an audio time length not exceeding 5 s, and only listen to comment audios from a specific audio source (for example, a specific comment website).

Optionally, in any embodiment of the present disclosure, in the comment list, the plurality of comment tags are rolled and updated in a constant speed, or they rolled and updated in an accelerated speed when the total number of the comment tags in waiting exceeds a preset value. Thus, when the number of available comments is large, a “Fast Come and Fast Go” mode is employed; for example, the comment tags in the comment list may be floated and updated from bottom to top in an accelerated speed, and the feeling of interaction may be realized visually by changing the speed according to user flow.

Optionally, in one embodiment, the comment list is provided on the video play screen and extends horizontally or verticality at the edge of the screen.

However, in another embodiment, optionally, the comment list and the video may be provided on different screens respectively. For example, the video is played on the screen of a personal computer or a network TV, while the comment list is displayed on the screen of a mobile phone or a tablet computer.

Optionally, in one embodiment, in the comment list that extends verticality, the plurality of comment tags may be arranged in a single column or in multiple columns in sequence (wherein, one column may contain a plurality of comment tags).

Optionally, in another embodiment, in the comment list that extends horizontally, the plurality of comment tags may be arranged in a single row or in multiple rows in sequence (wherein, one row may contain a plurality of comment tags).

Optionally, in one embodiment, the comment list may have a folded structure, wherein, a part of the comment tags are hidden and are redisplayed only when the mouse points to or clicks on a side edge of the comment list.

Optionally, in one embodiment, in the comment list, the plurality of comment tags are arranged in sequence according to their priorities (which is as described above).

Optionally, in one embodiment, a plurality of comment tags may be arranged in sequence according to the audio start time points corresponding to the play time points of the videos.

In one embodiment, if the audio start time points of a plurality of comment audios correspond to the same play time point of the video, preferably, the plurality of comment tags of which the audio start time points correspond to the same play time point of the video may be arranged in sequence according to the audio time lengths.

In one embodiment, if the audio start time points of a plurality of comment audios correspond to the same play time point of the video, preferably, a first set of plurality of comment tags of which the audio start time points correspond to a first play time point of the video may be arranged in sequence in a first column (or a first row) according to the audio time lengths, and a second set of plurality of comment tags of which the audio start time points correspond to a second play time point of the video may be arranged in sequence in a second column (or a second row) according to the audio time lengths.

In these embodiments, a plurality of comment tags are arranged in a comment list by taking the audio time length as attribute example of the priority; however, as required, in other embodiments, a plurality of comment tags may also be arranged in the comment list according to the priorities of other attributes.

Optionally, in any embodiment of the present disclosure, the comment tag displays one or more of the attributes of the comment audio (for example, audio start time point, audio time length, audio source and audio author). These attributes displayed by the comment tag may be displayed in literals, or they may be displayed by a static or dynamic image. For example, the comment tag displays the audio time length by literals (or digit), and displays the audio author by a static image, and displays the audio author of the comment audio being played by a dynamic image (for example, a blinking image).

Optionally, in any embodiment of the present disclosure, the comment list may include a hidden comment tag, which is displayed only when a mouse points to or clicks on a side edge of the comment list. Thus, the comment list may contain more comment tags for being used by the user.

In one embodiment, the hidden comment tag includes a comment tag of a comment audio corresponding to the next play time point of the video with a comment audio, thereby only a comment tag of the comment audio corresponding to the current play time point of the video may be displayed in the current comment list, and the comment tags of the subsequent comment audios may be hidden temporarily; on one hand, the size of the comment list may be reduced so as to decrease the visual interference on the video visual image that is being played currently, and on the other hand, when the number of available comment audios is large, user visual persecution caused by the rapid rolling and updating of comment tags may be avoided.

In another embodiment, the hidden comment tag includes: a comment tag of a comment audio that has a low priority or is filtered off (the descriptions of priority and filter are as described above), thus it may be used by the user during priority configuration and filtering operation.

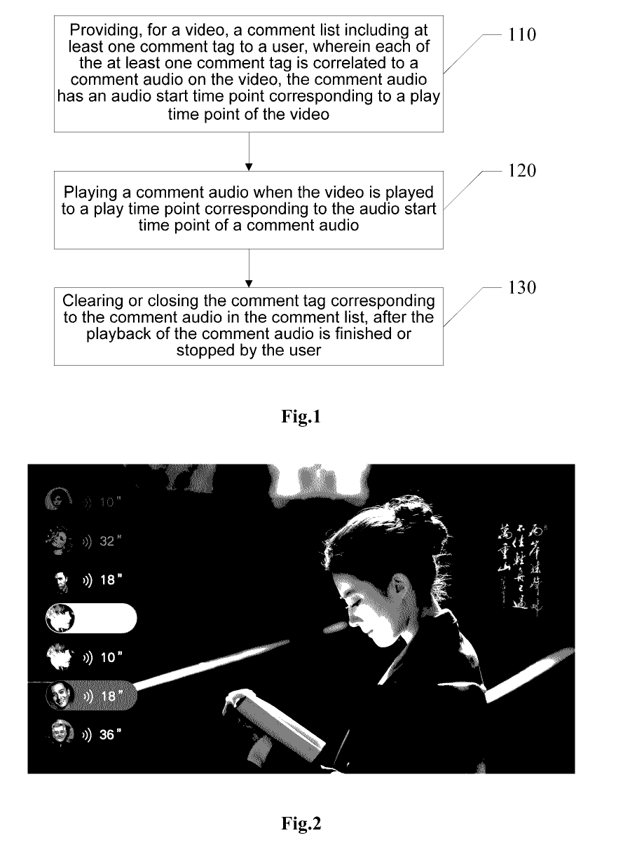

FIG. 2 is a screen shot showing the software operation of a video play method according to one embodiment of the present disclosure.

It may be seen from FIG. 2 that, in the running of the software configured for realizing the video play method according to the embodiment of the present disclosure, during video play, a comment list including a plurality of (7, shown in FIG. 2) comment tags is provided to the user on the top left of the screen, wherein each comment tag is correlated to a comment audio on the video, and the comment audio has an audio start time point corresponding to a play time point of the video. When the video is played to the play time point corresponding to the audio start time point of the comment audio, the comment audio is played (in FIG. 2, the author of the comment audio is displayed by a picture/photo, and the audio time length of the comment audio is also displayed in each comment tag). After the play of the comment audio is finished, the comment tag corresponding to the comment audio in the comment list is cleared or closed. In the comment list, the user may perform an individualized operation via a manual action (for example, mouse click or finger click).

According to one embodiment in another aspect of the present disclosure, there provides a video play system, which includes:

a comment list display module, provides, for a video, a comment list including at least one comment tag to a user, wherein each of the at least one comment tag is correlated to a comment audio on the video, the comment audio has an audio start time point corresponding to a play time point of the video;

an audio play module, plays the comment audio when the video is played to a play time point corresponding to the audio start time point of a comment audio;

Wherein, after the playback of the comment audio is finished or stopped by the user, the comment list display module clears or closes the comment tag corresponding to the comment audio in the comment list.

Optionally, in any embodiment of the present disclosure, the audio play module includes: a volume adjustment module, lowers the volume of the video when the comment audio is being played and recovering the volume of the video to its original volume when the playback of the comment audio is finished or stopped or paused by the user.

Optionally, in any embodiment of the present disclosure, the audio play module includes: a multi-audio control module, plays a first comment audio when the video is played to a first play time point corresponding to the audio start time point of the first comment audio, and stops playing the first comment audio and playing a second comment audio when the video is played to a second play time point, which is behind the first play time point, corresponding to the audio start time point of the second comment audio.

Optionally, in any embodiment of the present disclosure, the multi-audio control module arranges and/or plays a plurality of comment audios in the comment list in sequence according to their priorities in a case where the audio start time points of the plurality of comment audios correspond to a same play time point, wherein the priorities are determined by one or more of audio time length, audio source and audio author of the comment audios.

Optionally, in any embodiment of the present disclosure, the comment list display module displays a comment tag that meets a filter condition in the comment list, wherein, the filter condition includes: audio time length of the comment audio corresponding to the comment tag being in a preset range, source of the comment audio and author of the comment audio.

Optionally, in any embodiment of the present disclosure, the comment list display module enables the comment tag display one or more of the audio start time point, audio time length, audio source and audio author of the comment audio.

Optionally, in any embodiment of the present disclosure, the comment list display module enables the comment list include a hidden comment tag, which is displayed when a mouse points to or clicks on a side edge of the comment list.

By the video play method and the video play system according to the embodiments of the present disclosure, a more vivid comment environment and a more comfortable visual effect can be provided to a viewer.

One embodiment of the present disclosure further provides a terminal, which includes a part or all of the modules of a video play system according to the above embodiments.

The embodiment of the present disclosure further provides a non-volatile computer storage medium storing computer-executable instructions configured to execute the video play methods provided in the above-mentioned method embodiments.

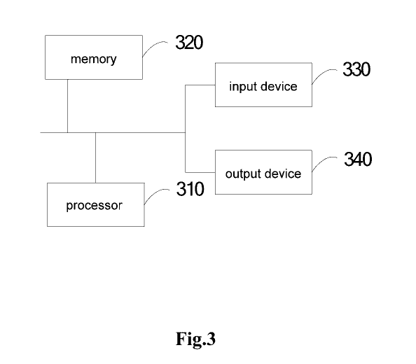

FIG. 3 is a block diagram of the electronic device that executes the video play method according to the embodiment of the present disclosure. As shown in FIG. 3, the apparatus includes:

One or more processors 310 and memory 320. In FIG. 3, take one processor 310 as the example.

The device that executes the video play method may further include: input device 330 and output device 340.

The processor 310, memory 320, input device 330 and output device 340 may be connected by bus or other means. FIG. 3 shows the example that the devices are connected by bus.

The memory 320 is a non-volatile computer-readable storage media, which may be used to store non-volatile software program, non-volatile computer-executable program and module, such as the program instruction/module corresponding to the video play method of the embodiments of the present disclosure. The processor 310 may perform various functions and applications of the server and process data by running the non-volatile software program, instruction and module stored in the memory 320, so as to realize the video play methods provided in the above-mentioned method embodiments.

The memory 320 may include a program storage area and a data storage area, wherein the program storage area may store an operation system and an application program for achieving at least one function; the data storage area may store data created according to the using of the processing apparatus for playing video. In addition, the memory 320 may include a high-speed random access memory, and may further include a non-volatile memory, such as at least one magnetic disk memory, flash memory or other non-volatile solid state memory. In some embodiments, the memory 320 may preferably include memories set remotely with respect to the processor 310, wherein these remote memories may be connected to the processing apparatus for playing video via the network. The examples of the network include but are not limited to internet, intranet, local area network (LAN), mobile communication network and combinations thereof.

The input device 330 may receive the information of a number or a character as inputted, and generate key input signals relating to the user setting and function control of the device for playing video. The output device 340 may include a display device such as a display screen.

The one or more modules are stored in the memory 320. When the one or more modules are executed by one or more processors 310, the video play method according to any of the above embodiments are executed.

The above product may execute the method provided by the embodiments of the present disclosure, and has the corresponding functional module for executing the method, and therefore has beneficial effect. For the details that are not fully described in this example, please refer to the methods provided by the embodiments of the present disclosure.

The electronic device in the embodiment of the present disclosure exists in various forms, including but not limited to:

(1) mobile communication apparatus, characterized in having a function of mobile communication mainly aimed at providing speech and data communication, wherein such terminal includes: smart phone (such as iPhone), multimedia phone, functional phone, low end phone and the like;

(2) ultra mobile personal computer apparatus, which falls in a scope of personal computer, has functions of calculation and processing, and generally has characteristics of mobile internet access, wherein such terminal includes: PDA, MID and UMPC devices, such as iPad;

(3) portable entertainment apparatus, which can display and play multimedia contents, and includes audio or video player (such as iPod), portable game console, E-book and intelligent toys and portable vehicle navigation apparatus;

(4) server, an apparatus for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A video play method, which is applied to an electronic device, comprising:
providing, for a video, a comment list comprising at least one comment tag to a user, wherein each of the at least one comment tag is correlated to a comment audio on the video, the comment audio has an audio start time point corresponding to a play time point of the video;
playing the comment audio when the video is played to a play time point corresponding to the audio start time point of a comment audio; and
clearing or closing the comment tag corresponding to the comment audio in the comment list, after the playback of the comment audio is finished or stopped by the user.

2. The method according to claim 1, further comprising:
lowering the volume of the video when the comment audio is being played; and
recovering the volume of the video to its original volume when the playback of the comment audio is finished or stopped or paused by the user.

3. The method according to claim 1, further comprising:
playing a first comment audio when the video is played to a first play time point corresponding to the audio start time point of the first comment audio; and
stopping playing the first comment audio and playing a second comment audio when the video is played to a second play time point, which is behind the first play time point, corresponding to the audio start time point of the second comment audio.

4. The method according to claim 1, comprising:
arranging and/or playing a plurality of comment audios in the comment list in sequence according to their priorities in a case where the audio start time points of the plurality of comment audios correspond to a same play time point, wherein the priorities are determined by one or more of audio time length, audio source and audio author of the comment audios.

5. The method according to claim 1, wherein:
a comment tag that meets a filter condition is displayed in the comment list, wherein, the filter condition comprises: audio time length of the comment audio corresponding to the comment tag being in a preset range, source of the comment audio and author of the comment audio.

6. The video play method according to claim 1, wherein:
the comment tag displays one or more of the audio start time point, audio time length, audio source and audio author of the comment audio.

7. The method according to any claim 1, wherein:
the comment list comprises a hidden comment tag, which is displayed when a mouse points to or clicks on a side edge of the comment list.

8. A non-volatile computer-readable storage medium storing executable instructions that, when executed by an electronic device, cause the electronic device to:
provide, for a video, a comment list comprising at least one comment tag to a user, wherein each of the at least one comment tag is correlated to a comment audio on the video, the comment audio has an audio start time point corresponding to a play time point of the video;
play the comment audio when the video is played to a play time point corresponding to the audio start time point of a comment audio; and
clear or close the comment tag corresponding to the comment audio in the comment list, after the playback of the comment audio is finished or stopped by the user.

9. The non-volatile computer-readable storage medium according to claim 8, wherein the electronic device is further caused to:
lower the volume of the video when the comment audio is being played; and
recover the volume of the video to its original volume when the playback of the comment audio is finished or stopped or paused by the user.

10. The non-volatile computer-readable storage medium according to claim 8, wherein the electronic device is further caused to:
play a first comment audio when the video is played to a first play time point corresponding to the audio start time point of the first comment audio; and
stop playing the first comment audio and play a second comment audio when the video is played to a second play time point, which is behind the first play time point, corresponding to the audio start time point of the second comment audio.

11. The non-volatile computer-readable storage medium according to any one of claims 8-10, wherein the electronic device is further caused to:
arrange and/or play a plurality of comment audios in the comment list in sequence according to their priorities in a case where the audio start time points of the plurality of comment audios correspond to a same play time point, wherein the priorities are determined by one or more of audio time length, audio source and audio author of the comment audios.

12. The non-volatile computer-readable storage medium according to any one of claims 8-10, wherein:
a comment tag that meets a filter condition is displayed in the comment list, wherein, the filter condition comprises: audio time length of the comment audio corresponding to the comment tag being in a preset range, source of the comment audio and author of the comment audio.

13. The non-volatile computer-readable storage medium according to any one of claims 8-10, wherein,
the comment list comprises a hidden comment tag, which is displayed when a mouse points to or clicks on a side edge of the comment list.

14. An electronic device, comprising:
at least one processor; and
a memory communicably connected with the at least one processor for storing instructions executable by the at least one processor, wherein execution of the instructions by the at least one processor causes the at least one processor to:
provide, for a video, a comment list comprising at least one comment tag to a user, wherein each of the at least one comment tag is correlated to a comment audio on the video, the comment audio has an audio start time point corresponding to a play time point of the video;
play the comment audio when the video is played to a play time point corresponding to the audio start time point of a comment audio; and
clear or close the comment tag corresponding to the comment audio in the comment list, after the playback of the comment audio is finished or stopped by the user.

15. The electronic device according to claim 14, wherein the at least one processor is further caused to:
lower the volume of the video when the comment audio is being played; and
recover the volume of the video to its original volume when the playback of the comment audio is finished or stopped or paused by the user.

16. The electronic device according to claim 14, wherein the at least one processor is further caused to:
play a first comment audio when the video is played to a first play time point corresponding to the audio start time point of the first comment audio; and
stop playing the first comment audio and play a second comment audio when the video is played to a second play time point, which is behind the first play time point, corresponding to the audio start time point of the second comment audio.

17. The electronic device according to claim 14, wherein the at least one processor is further caused to:
arrange and/or play a plurality of comment audios in the comment list in sequence according to their priorities in a case where the audio start time points of the plurality of comment audios correspond to a same play time point, wherein the priorities are determined by one or more of audio time length, audio source and audio author of the comment audios.

18. The electronic device according to 14, wherein,
a comment tag that meets a filter condition is displayed in the comment list, wherein, the filter condition comprises: audio time length of the comment audio corresponding to the comment tag being in a preset range, source of the comment audio and author of the comment audio.

19. The electronic device according to claim 14, wherein,
the comment tag displays one or more of the audio start time point, audio time length, audio source and audio author of the comment audio.

20. The electronic device according to claim 14, wherein,
the comment list comprises a hidden comment tag, which is displayed when a mouse points to or clicks on a side edge of the comment list.
